(19) United States
(12) Patent Application Publication
(10) Pub. No.: US 2026/0280608 A1
(43) Pub. Date: Sep. 17, 2026

(54) MULTI-ACCESS POINT COORDINATED BEAMFORMING

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US); Jiayi Zhang, Rockville, MD (US)

(73) Assignee: Ofinno, LLC, Reston, VA (US)

(21) Appl. No.: 19/684,224

(22) Filed: May 21, 2026

Related U.S. Application Data
(63) Continuation of application No. PCT/US2024/056633, filed on Nov. 20, 2024.
(60) Provisional application No. 63/601,791, filed on Nov. 22, 2023.

(51) Int. Cl. H04B 7/024; H04B 7/06; H04L 1/00

(52) U.S. Cl. CPC H04B 7/024; H04B 7/0617; H04L 1/0003; H04L 1/0009

(57) ABSTRACT

A first access point (AP) receives, from a second AP, a frame. The frame indicates a beamforming transmission by the first AP and the second AP, and an acceptable receive interference level (ARIL), at a first station (STA) associated with the second AP, of a physical layer protocol data unit (PPDU) transmitted, by the first AP to a second STA associated with the first AP, for the beamforming transmission. The first AP determines, based on the ARIL, a set of beamforming weights for the beamforming transmission. The first AP transmits, to the second STA and for the beamforming transmission, the PPDU beamformed based on the set of beamforming weights.

### CROSS-REFERENCE TO RELATED APPLICATIONS

This application is a continuation of International Application No. PCT/US2024/056633, filed Nov. 20, 2024, which claims the benefit of U.S. Provisional Application No. 63/601,791, filed Nov. 22, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example multi-AP network.

FIG. 4 illustrates Enhanced Distributed Channel Access (EDCA) and Coordinated Orthogonal Frequency Division Multiple Access (COFDMA).

FIG. 5 illustrates an example network that includes a coordinated AP set.

FIG. 6 illustrates an example multi-AP operation procedure.

FIG. 7 illustrates an example multi-AP sounding phase.

FIG. 8 illustrates an example multi-AP downlink data transmission phase.

FIG. 9 illustrates an example multi-AP uplink data transmission phase.

FIG. 10 illustrates an example of a coordinated beamforming procedure.

FIG. 11 illustrates an example of another coordinated beamforming procedure.

FIG. 12 illustrates an example of a coordinated beamforming procedure according to an embodiment.

FIG. 13 illustrates an example of another coordinated beamforming procedure according to an embodiment.

FIG. 14 illustrates an example of another coordinated beamforming procedure according to an embodiment.

FIG. 15 illustrates an example of a trigger frame that may be used in embodiments.

FIG. 16 illustrates an example process according to an embodiment.

FIG. 17 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

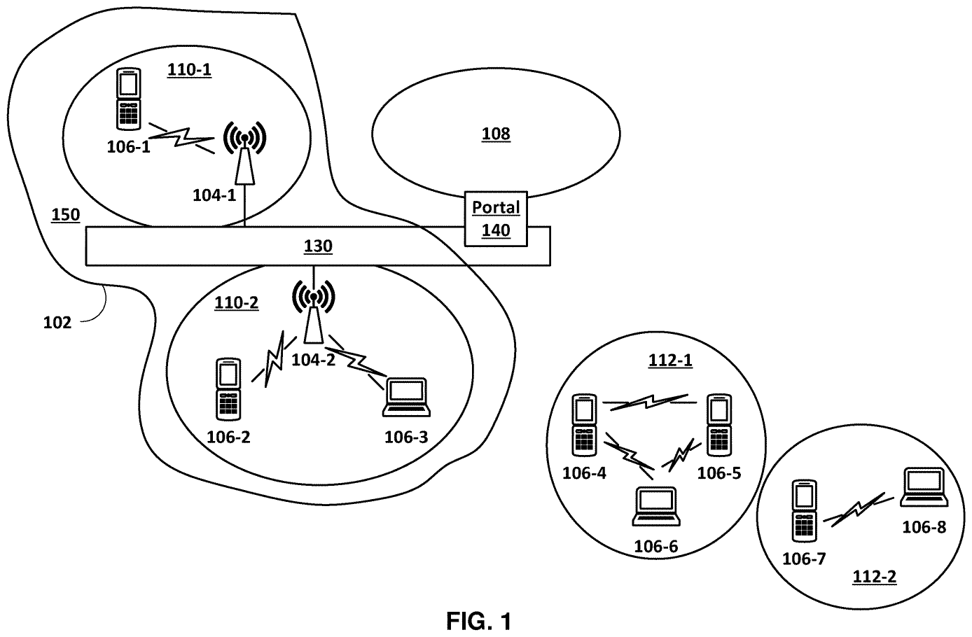

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

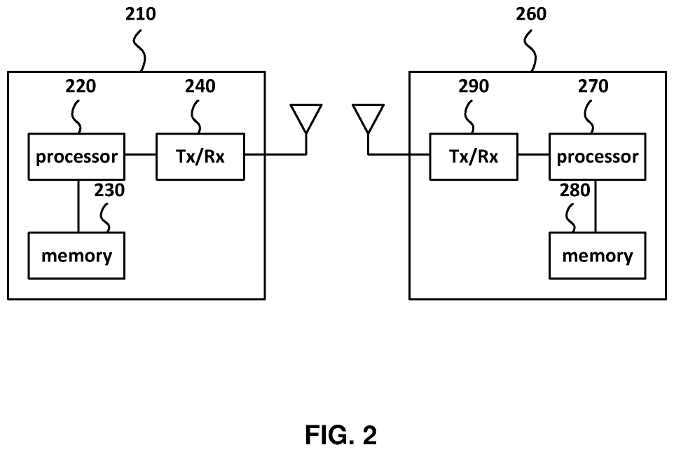

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

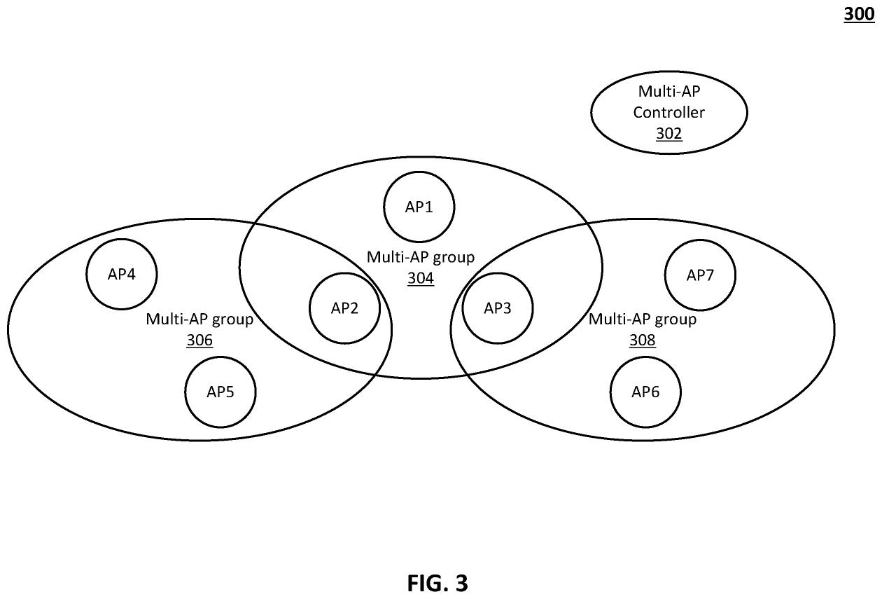

FIG. 3 illustrates an example multi-AP network 300. Example multi-AP network 300 may be a multi-AP network in accordance with the Wi-Fi Alliance standard specification for multi-AP networks. As shown in FIG. 3, multi-AP network 300 may include a multi-AP controller 302 and a plurality of multi-AP groups (or multi-AP sets) 304, 306, and 308.

Multi-AP controller 302 may be a logical entity that implements logic for controlling the APs in multi-AP network 300. Multi-AP controller 302 may receive capability information and measurements from the APs and may trigger AP control commands and operations on the APs. Multi-AP controller 302 may also provide onboarding functionality to onboard and provision APs onto multi-AP network 300.

Multi-AP groups 304, 306, and 308 may each include a plurality of APs. APs in a multi-AP group are in communication range of each other and may coordinate their transmissions and/or transmissions from their associated STAs. Coordinated transmissions may involve all or a subset of the APs in a multi-AP group. A multi-AP group may also be referred to as an AP candidate set as APs in a multi-AP group are considered candidates for a coordinated transmission initiated by an AP. The APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, a multi-AP group may be established by a coordinator AP in a multi-AP setup phase prior to any multi-AP coordination. APs of the multi-AP group, other than the coordinator AP, may be referred to as the coordinated APs. A coordinator AP may establish one or more multi-AP groups. A coordinated AP may likewise be a member of multiple multi-AP groups. A coordinator AP of a multi-AP group may be a coordinated AP of another multi-AP group, and vice versa. In another approach, a multi-AP group may be established by a network administrator manually by configuring APs as part of the multi-AP group. In yet another approach, a multi-AP group may be established in a distributed manner by APs without a central controller. In this case, an AP may advertise its multi-AP capability in a beacon or other management frame (e.g., public action frame). Other APs that receive the frame with the multi-AP capability information may perform a multi-AP setup with the AP that advertised the multi-AP capability.

In one approach, one of the APs in a multi-AP group may be designated as a master AP. The designation of the master AP may be done by AP controller 302 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may perform coordinated transmissions together. One aspect of coordination may include coordination to perform coordinated transmissions within the multi-AP group. As used herein, a coordinated transmission, also referred to as a multi-AP transmission, is a transmission event in which multiple APs (of a multi-AP group or a multi-AP network) transmit in a coordinated manner over a time period. Coordinated transmissions may involve simultaneous transmissions of a plurality of APs in a multi-AP group. The time period of simultaneous AP transmission may be a continuous period. The multi-AP transmission may use different transmission techniques, such as Coordinated OFDMA (COFDMA), Coordinated Spatial Reuse (CSR), Joint Transmission or Reception (JT/JR), Coordinated Beamforming (CBF), and CTDMA, or a combination of two or more of the aforementioned techniques.

Multi-AP transmissions may be enabled by the AP controller and/or by the master AP of the multi-AP group. In one approach, the AP controller and/or the master AP may control time and/or frequency sharing in a transmission opportunity (TXOP). For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Different multi-AP transmission schemes may be suitable for different use cases in terms of privacy protection, including whether transmitted data may be shared with other BSSs in the multi-AP group. For example, some multi-AP transmission schemes, such as CSR, CDTMA, coordinated frequency division multiple access (CFDMA), COFDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling requires that data transmissions between an AP and STAs are only within the same BSS. In other words, each AP transmits or receives data frames to or from its associated STAs, while each STA receives or transmits data frames to or from its associating AP.

By contrast, other multi-AP transmission schemes may enable a master AP to coordinate slave APs by sharing both control information and user data among APs in a multi-AP group. Control information may include BSS information related to APs and link quality information of channels between each AP and its associated STAs. By having user data exchanged over backhaul, the master AP and slave APs may perform data transmissions jointly to achieve spatial diversity, e.g., using distributed MIMO, for example, joint transmission (JT) for downlink transmissions and joint reception (JR) for uplink transmissions. The data transmissions between APs and STAs may include transmissions within the same BSS and/or across different BSSs. In other words, an AP may transmit or receive data frames to or from its associated STAs as well STAs associated with other APs participating in multi-AP transmission. Similarly, a STA may transmit or receive data frames to or from multiple APs.

Different multi-AP transmission schemes may be suitable for different use cases in terms of signal reception levels at STAs or APs within a multi-AP group. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as channel state information (CSI), channel quality indication (CQI), or compressed beamforming (BF) feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as a backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. CFDMA, COFDMA and CTDMA may require medium or relatively low complexity due to the CSI and time/frequency resources to be shared between APs. CSR may require low complexity as the amount of information related to spatial reuse and traffic that needs to be exchanged between APs may be low.

A multi-AP group may adopt a static multi-AP operation including a static multi-AP transmission scheme. A multi-AP network may also be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

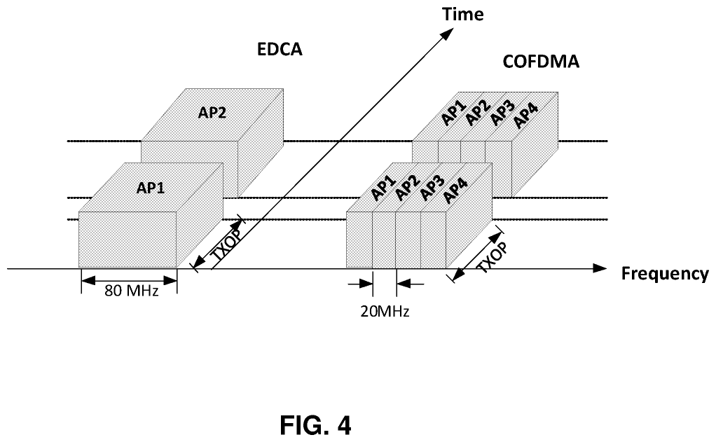

In COFDMA, the master AP may share a portion of its TXOP with multiple APs by assigning each of the multiple APs a respective frequency resource (e.g., channel/subchannel) of available frequency resources. COFDMA is illustrated in FIG. 4 as a multi-AP channel access, compared with Enhanced Distributed Channel Access (EDCA). As shown in FIG. 4, in EDCA, channel access by multiple APs (e.g., AP1, AP2) may occur in consecutive time periods (e.g., TXOPs). During a given channel access, the channel (e.g., 80 MHz) in its entirety may be used by a single AP. In contrast, in COFDMA, access by multiple APs (multi-AP channel access) may take place in a same time period (e.g., same TXOP or same portion of a TXOP) over orthogonal frequency resources. For example, as shown in FIG. 4, an 80 MHz channel may be divided into four non-overlapping 20 MHz channels, each assigned to a respective AP of the multiple APs. The multiple APs may transmit in a coordinated manner, simultaneously in the same time period, to achieve a multi-AP transmission. In the multi-AP transmission, each of the multiple APs may transmit a PPDU to one or more STAs.

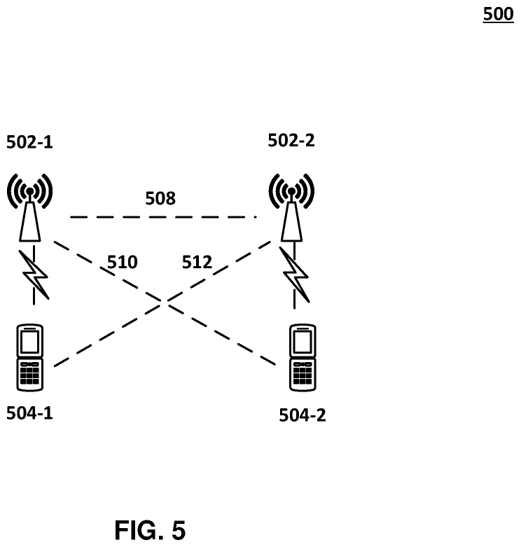

FIG. 5 illustrates an example network 500 that includes a coordinated AP set. As shown in FIG. 5, the coordinated AP set may include two APs-AP 502-1 and AP 502-2. The coordinated AP set may be a subset of an established multi-AP group. At least one STA may be associated with each of APs 502-1 and 502-2. For example, a STA 504-1 may be associated with AP 502-1, and a STA 504-2 may be associated with AP 502-2.

APs 502-1 and 502-2 may belong to the same ESS as described above in FIG. 1. In such a case, APs 502-1 and 502-2 may be connected by a DS to support ESS features. In addition, as part of a coordinated AP set, APs 502-1 and 502-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 502-1 and 502-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 5, if AP 502-1 supports JT and CSR while AP 502-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 502-1 and AP 502-2 as shown in FIG. 5. Spatial reuse using CSR can be more stable than non-AP coordinated spatial reuse schemes such as OBSS PD-based SR and PSR-based SR. For example, in example network 500, APs 502-1 and 502-2 may perform a joint sounding operation in order to measure path loss (PL) on paths of example network 500. For example, the joint sounding operation may result in the measurement of PL 508 for the path between APs 502-1 and 502-2, path loss 510 for the path between AP 502-1 and STA 504-2, and path loss 512 for the path between AP 502-2 and STA 504-1. The measured path loss information may then be shared between APs 502-1 and 502-2 (e.g., using the backhaul) to allow for simultaneous transmissions by APs 502-1 and 502-2 to their associated STAs 504-1 and 504-2 respectively. Specifically, one of APs 502-1 and 502-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

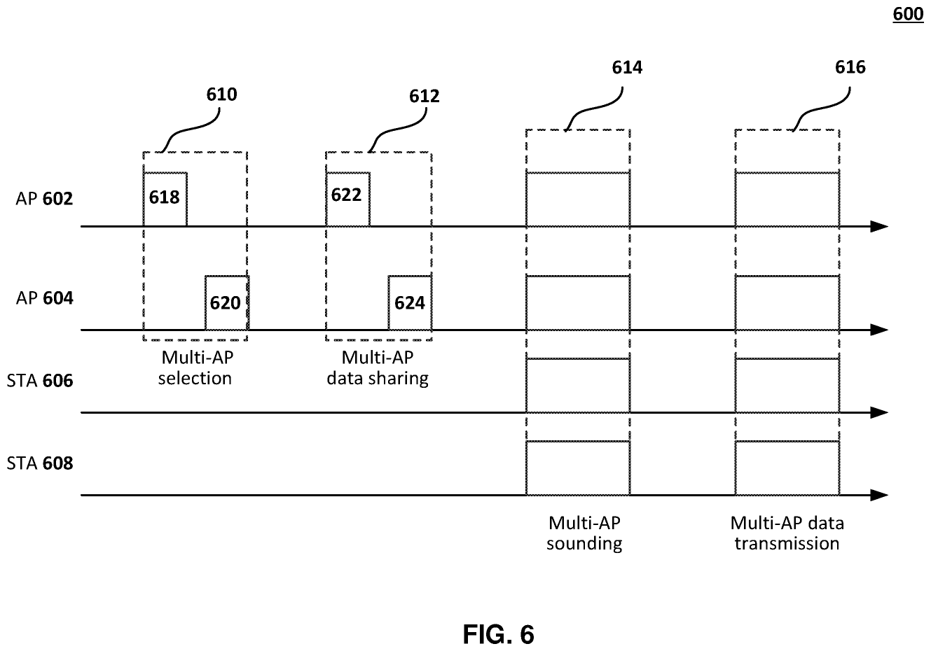

FIG. 6 illustrates an example 600 of a multi-AP operation procedure. In example 600, the multi-AP operation procedure is illustrated with respect to a multi-AP network that includes APs 602 and 604 and STAs 606 and 608. In an example, APs 602 and 604 may form a multi-AP group. AP 602 may be the master AP and AP 604 may be a slave AP of the multi-AP group. For example, AP 602 may obtain a TXOP making it the master AP of the multi-AP group. Alternatively, AP 602 may be designated as the master AP by a multi-AP controller.

As shown in FIG. 6, the multi-AP operation procedure may include a series of phases in time, each of which may contain a plurality of frame exchanges within the multi-AP network. Specifically, the multi-AP operation procedure may include a multi-AP selection phase 610, a multi-AP data sharing phase 612, a multi-AP sounding phase 614, and a multi-AP data transmission phase 616.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 610 may include procedures for soliciting, selecting, or designating slave AP(s) for a multi-AP group by a master AP. As seen in FIG. 6, the multi-AP selection phase may include transmissions of frame 618 from AP 602 and frame 620 from AP 604. AP 602 may transmit frame 618 to solicit information regarding the buffer status of AP 604. In response, AP 604 may transmit frame 620 to inform AP 602 of its and its associated STAs buffer status and/or whether it intends to join multi-AP operation. Multi-AP selection phase 610 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 612 may include procedures for sharing data frames to be transmitted by APs to associated STAs among the master AP and selected slave AP(s) via direct connections between APs. Phase 612 may be optional for some multi-AP data transmission schemes. For example, phase 612 may be required for JT/JR as data frames may be exchanged between APs before or after multi-AP data transmission phase 616.

Multi-AP data sharing phase 612 may be performed using a wired backhaul, an in-channel wireless backhaul, or an off-channel wireless backhaul. In some cases, multi-AP data sharing phase 612 may be performed over an in-channel backhaul, e.g., using the same wireless channel used to transmit/receive data to/from STAs. For example, as shown in FIG. 6, in phase 612, AP 602 may transmit a frame 622, which may be received by AP 604. Frame 622 may include MPDUs that AP 602 wishes to transmit to associated STAs using a multi-AP operation. Similarly, AP 604 may transmit a frame 624, which may be received by AP 602. Frame 624 may include MPDUs that AP 604 wishes to transmit to associated STAs using a multi-AP operation.

Multi-AP sounding phase 614 may include procedures for multi-AP channel sounding, including channel estimation and feedback of channel estimates among the master AP, candidate slave AP(s), and associated STAs. Phase 614 may be optional for some multi-AP transmission schemes, such as COFDMA, CDTMA, and CSR. For example, phase 614 may be performed by the master AP to aid in resource unit allocation when orchestrating a COFDMA transmission.

Multi-AP data transmission phase 616 may include exchange of data frames between the master AP, slave AP(s), and their associated STAs based on multi-AP transmission scheme(s) determined by the master AP. Depending on the multi-AP transmission scheme(s) to be used, phase 616 may include optional synchronization between APs of the multi-AP group, before exchange of data frames between APs and STAs within the multi-AP group.

The order of phases 610, 612, 614 and 616 may be different than shown in FIG. 6. For example, in COFDMA, phase 616 may occur immediately after phase 610, whereas, in JT/JR, phase 612 may occur after phase 610. Further, as mentioned above, some phases may be optional and may or may not be present. For example, phase 614 may not be required for COFDMA but may be required for JT/JR.

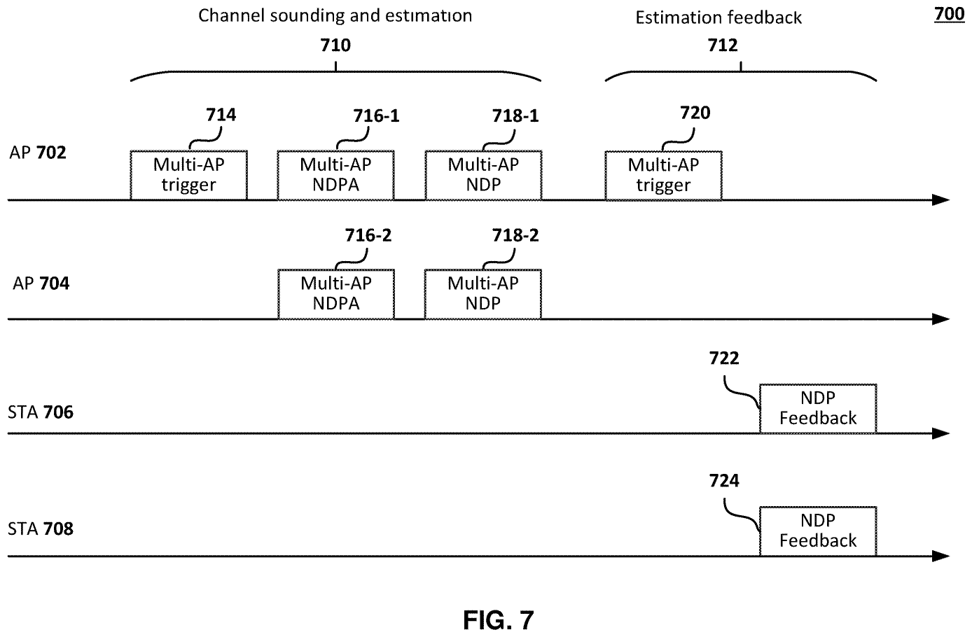

FIG. 7 illustrates an example 700 of a multi-AP sounding phase. Multi-AP sounding phase 700 may be an example of multi-AP sounding phase 614. As shown in FIG. 7, example 700 may include a master AP 702 and a slave AP 704 of a multi-AP group. Example 700 may further include a STA 706 associated with AP 702 and a STA 708 associated with AP 704.

As shown in FIG. 7, multi-AP sounding phase 700 may include frame exchanges to allow AP 702 (the master AP) to acquire channel state information (CSI) of channels in the multi-AP group. In an implementation, phase 700 may include a first subphase 710 and a second subphase 712.

During the first subphase 710, APs may initiate channel sounding and STAs may estimate channel state information (CSI). For example, AP 702 may transmit a frame 714 to AP 704 (the slave AP) to trigger multi-AP sounding. Frame 714 may comprise a multi-AP trigger frame. Subsequently, APs 702 and 704 may transmit respectively announcement frames 716-1 and 716-2 to their respective associated STAs 706 and 708 to announce the transmission of sounding frames. Frames 716-1 and 716-2 may comprise multi-AP null data packet announcement (NDPA) frames. Frames 716-1 and 716-2 may be transmitted simultaneously. Next, APs 702 and 704 may transmit respectively frames 718-1 and 718-2 to STAs 706 and 708 respectively. Frames 718-1 and 718-2 may comprise multi-AP null data packet (NDP) frames. STAs 706 and 708 receive frames 718-1 and 718-2 respectively and perform channel estimation of the channels from AP 702 to STA 706 and from AP 704 to STA 708, respectively.

During the second subphase 712, APs may initiate a procedure for STAs to feed back channel estimates to the APs. For example, AP 702 may transmit a frame 720 to trigger STAs 706 and 708 to transmit their channel estimates to APs 702 and 704 respectively. Frame 720 may comprise a multi-AP trigger frame. In response, STAs 706 and 708 may transmit respectively frames 722 and 724 including feedback of channel estimates to APs 702 and 704 respectively. Frames 722 and 724 may comprise NDP feedback frames. The feedback of channel estimates may include NDP feedback, CSI-related information, a beamforming report (BFR), or a channel quality indication (CQI) report.

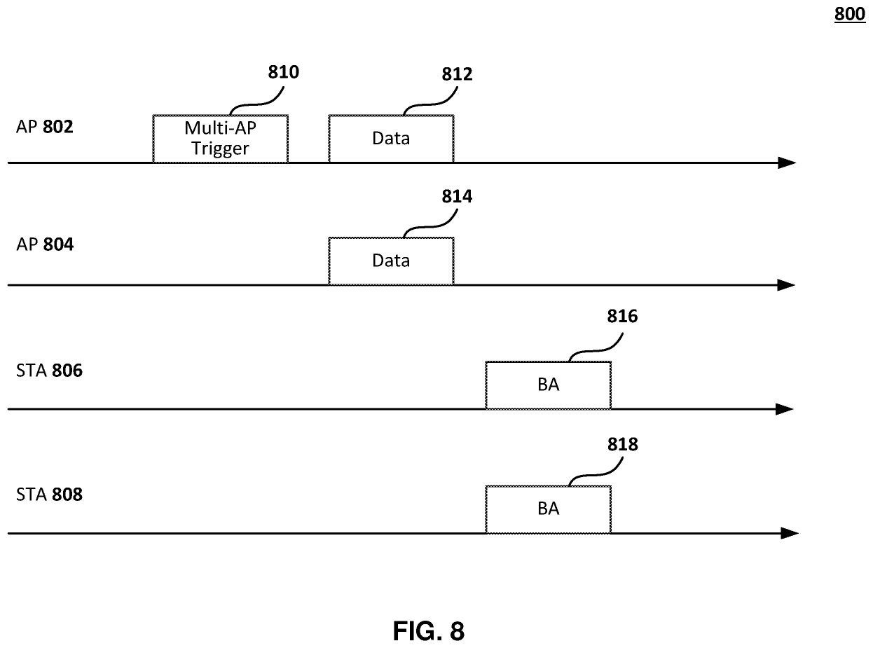

FIG. 8 illustrates an example 800 of a multi-AP downlink data transmission phase. Multi-AP downlink data transmission phase 800 may be an example of multi-AP data transmission phase 616. As shown in FIG. 8, example 800 may include a master AP 802 and a slave AP 804 of a multi-AP group. Example 800 may further include a STA 806 associated with AP 802, and a STA 808 associated with AP 804.

As shown in FIG. 8, multi-AP downlink data transmission phase 800 may include frame exchanges to enable master AP 802 to coordinate with slave AP 804 to perform specific multi-AP transmission schemes with their associated STAs 806 and 808 respectively. The multi-AP transmission schemes may include COFDMA, CTDMA, CSR, CBF, JT/JR, or a combination of two or more of the aforementioned schemes.

As shown in FIG. 8, master AP 802 may begin phase 800 by transmitting a frame 810 to AP 804. Frame 810 may include information related to AP 804 (e.g., an identifier of AP 804), synchronization information, information related to a specific multi-AP transmission scheme to be used, and/or information related to a resource unit (RU) for use by AP 804 to acknowledge frame 810. Frame 810 may comprise a control frame. For example, frame 810 may comprise a multi-AP trigger frame.

Slave AP 804 may receive frame 810 and may use the synchronization information to synchronize with master AP 802. Subsequently, APs 802 and 804 may perform data transmission to their associated STAs 806 and 808 respectively. Specifically, AP 802 may transmit a data frame 812 to its associated STA 806, and AP 804 may transmit a data frame 814 to its associated STA 808. Depending on the multi-AP transmission scheme being used, APs 802 and 804 may transmit frames 812 and 814 respectively to STAs in different BSSs. For example, when the multi-AP transmission scheme is JT/JR, AP 802 may also transmit frame 812 to STA 808 associated with slave AP 804, and AP 804 may also transmit frame 814 to STA 808 associated with AP 804. The resources for transmitting and receiving frames 812 and 814 may depend on the specific multi-AP transmission scheme adopted.

STAs 806 and 808 may acknowledge frames 812 and 814 respectively. For example, STA 806 may transmit a frame 816 to AP 802, and STA 808 may transmit a frame 818 to AP 804. Frames 816 and 818 may comprise block ack (BA) frames. STAs 806 and 808 may also transmit frames 816 and 818 to APs in different BSSs, when required by the used multi-AP transmission scheme. For example, when the multi-AP transmission scheme is JT/JR, STA 806 may also transmit frame 816 to AP 804, and STA 808 may also transmit frame 818 to AP 802. The resources for transmitting and receiving frames 816 and 818 may depend on the specific multi-AP transmission scheme adopted.

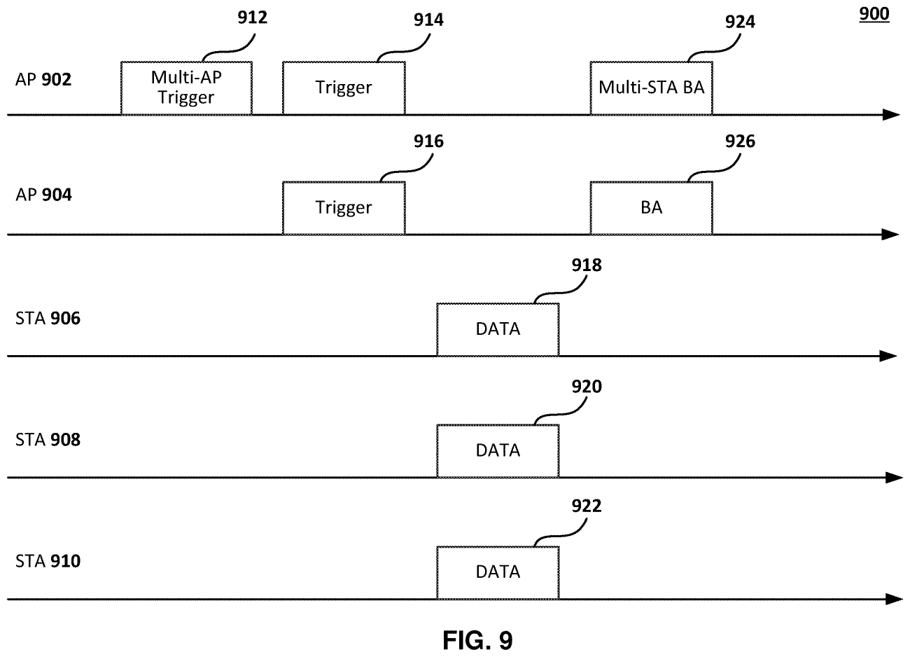

FIG. 9 illustrates an example 900 of a multi-AP uplink data transmission phase. Multi-AP uplink data transmission phase 900 may be an example of multi-AP data transmission phase 616. As shown in FIG. 9, example 900 may include a master AP 902 and a slave AP 904 of a multi-AP group. Example 900 may further include STAs 906 and 908 associated with AP 902, and a STA 910 associated with AP 904.

As shown in FIG. 9, multi-AP uplink data transmission phase 900 may include frame exchanges to enable master AP 902 to coordinate with slave AP 904 to perform specific multi-AP transmission schemes with STAs 906, 908, and 910. The multi-AP transmission schemes may include COFDMA, CTDMA, CSR, CBF, JT/JR, or a combination of two or more of the aforementioned schemes.

As shown in FIG. 9, master AP 902 may begin phase 900 by transmitting a frame 912 to AP 904. Frame 912 may include information related to AP 904 (e.g., an identifier of AP 904), synchronization information, information related to a specific multi-AP transmission scheme to be used, and/or information related to an RU for use by AP 904 to acknowledge frame 912. Frame 912 may comprise a control frame. For example, frame 912 may comprise a multi-AP trigger frame.

Slave AP 904 may receive frame 912 and may use the synchronization information to synchronize with master AP 902. Subsequently, APs 902 and 904 may solicit uplink data transmissions from their associated STAs 906, 908 and 910 using trigger frames. Specifically, AP 902 may transmit a trigger frame 914 to its associated STAs 906 and 908, and AP 904 may transmit a trigger frame 916 to its associated STA 910. Depending on the multi-AP transmission scheme being used, APs 902 and 904 may also transmit frames 914 and 916 respectively to STAs in different BSSs. For example, when the multi-AP transmission scheme is JT/JR, AP 902 may also transmit frame 914 to STA 910 associated with slave AP 904, and AP 904 may also transmit frame 916 to STAs 906 and 908 associated with AP 902. The resources for transmitting and receiving frames 914 and 916 may depend on the specific multi-AP transmission scheme adopted.

STAs 906 and 908 may respond to frame 914, STA 910 may respond to frame 916. For example, STAs 906 and 908 may transmit frames 918 and 920 respectively to AP 902, while STA 910 may transmit a frame 922 to AP 904. Frames 918, 920, and/or 922 may be transmitted simultaneously. Frames 918, 920, and 922 may comprise data frames or null data frames. STAs 906, 908, and 910 may also transmit frames 918, 920, and 922 respectively to APs in different BSSs, when required by the used multi-AP transmission scheme. For example, when the multi-AP transmission scheme is JT/JR, STAs 906 and 908 may also transmit respective frames 918 and 920 to AP 904, and STA 910 may also transmit frame 922 to AP 902. The resources for transmitting and receiving frames 918, 920, and 922 may depend on the specific multi-AP transmission scheme adopted. AP 902 may acknowledge frames 918 and 920 by transmitting a multi-STA BA frame 924 to STAs 906 and 908. AP 904 may acknowledge frame 922 by transmitting a BA frame 926 to STA 910.

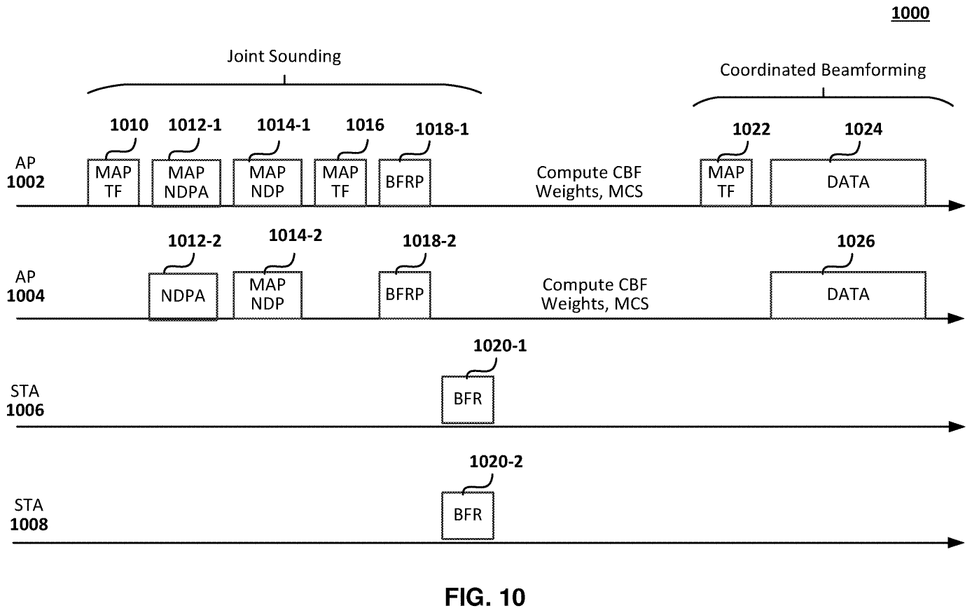

FIG. 10 illustrates an example 1000 of a coordinated beamforming procedure. A coordinated beamforming procedure allows two or more APs to transmit to multiple STAs using the same time and frequency resources with without interference. As shown in FIG. 10, example 1000 includes APs 1002 and 1004 and STAs 1006 and 1008. STAs 1006 and 1008 may be associated with APs 1002 and 1004 respectively. APs 1002 and 1004 may form a coordinated AP set. In example 1000, it is assumed that AP 1002 is a master AP of the coordinated AP set and that AP 1004 is a slave AP of the coordinated AP set.

In an implementation, the coordinated beamforming procedure may include a sounding phase/procedure, which APs 1002 and 1004 may use to acquire channel state information from STAs 1006 and 1008 respectively. The sounding phase/procedure may begin with AP 1002 transmitting a trigger frame 1010 to AP 1004. Trigger frame 1010 may be a multi-AP (MAP) trigger frame. Trigger frame 1010 triggers AP 1004 to perform a sounding procedure concurrently with AP 1002. Subsequently, APs 1002 and 1004 may initiate the sounding procedure by transmitting simultaneously NDPA frames 1012-1 and 1012-2 to STAs 1006 and 1008 respectively. NDPA frames 1012-1 and 1012-2 may be MAP NDPA frames. NDPA frame 1012-1 announces to STA 1006 the transmission of one or more sounding frames by AP 1002. NDPA frame 1012-2 announces to STA 1008 the transmission of one or more sounding frames by AP 1004. NDPA frames 1012-1 and 1012-2 may be duplicate frames.

Next, APs 1002 and 1004 may transmit simultaneously NDP frames 1014-1 and 1014-2 to STAs 1006 and 1008 respectively. NDP frames 1014-1 and 1014-2 may be a MAP NDP frames. NDP frames 1014-1 and 1014-2 may include Long Training fields (LTF)s corresponding to distinct spatial streams associated to APs 1002 and 1004 respectively. STAs 1006 and 1008 each receives NDP frames 1014-1 and 1014-2 and uses NDP frames 1014-1 and 1014-2 to estimate the downlink channel from AP 1002 and the downlink channel from AP 1004. In another implementation, APs 1002 and 1004 may transmit NDP frames 1014-1 and 1014-2 sequentially. STAs 1006 and 1008 each receives NDP frame 1014-1 and uses NDP frame 1014-1 to estimate the downlink channel from AP 1002. Similarly, STAs 1006 and 1008 each receives NDP frame 1014-2 and uses NDP frame 1014-2 to estimate the downlink channel from AP 1004.

Subsequently, AP 1002 may transmit a trigger frame 1016 to AP 1004. Trigger frame 1016 may be a MAP trigger frame. Trigger frame 1016 triggers AP 1004 to perform a channel estimation polling procedure concurrently with AP 1002. APs 1002 and 1004 may initiate the channel estimation polling procedure by transmitting simultaneously BFRP frames 1018-1 and 1018-2 to retrieve the downlink channel estimates from STAs 1006 and 1008. STAs 1006 and 1008 may respond to BFRP frames 1018-1 and 1018-2 respectively by transmitting respectively BFR frames 1020-1 and 1020-2. BFR frame 1020-1, transmitted to AP 1002, may include an estimate of the downlink channel from AP 1002 to STA 1006 and an estimate of the downlink channel from AP 1004 to STA 1006. BFR frame 1020-2, transmitted to AP 1004, may include an estimate of the downlink channel from AP 1004 to STA 1008 and an estimate of the downlink channel from AP 1002 to STA 1008.

In an implementation (not shown in FIG. 10), APs 1002 and 1004 may exchange the downlink channel estimates received respectively from STAs 1006 and 1008. As such, AP 1002 may obtain from AP 1004 the estimate of the downlink channel from AP 1002 to STA 1008, and AP 1004 may obtain from AP 1002 the estimate of the downlink channel from AP 1004 to STA 1006. In an implementation, the exchange of the downlink channel estimates may include AP 1002 transmitting a trigger frame to AP 1004 soliciting the sending, by AP 1004 to AP 1002, of the downlink channel estimates received from STA 1008. AP 1002 may include the downlink channel estimates received from STA 1006 in the trigger frame or in a separate frame transmitted to AP 1004. In another implementation, the exchange of the downlink channel estimates may be performed via a backhaul link.

Using the obtained downlink channel estimates, APs 1002 and 1004 may each compute a respective set of beamforming weights for a coordinated beamforming transmission comprising APs 1002 and 1004. APs 1002 and 1004 may each further determine a respective modulation and coding scheme (MCS) for the coordinated beamforming transmission. As shown in FIG. 10, the coordinated beamforming transmission may comprise a first beamforming transmission 1024 by AP 1002 and a second beamforming transmission 1026 by AP 1004. First beamforming transmission 1024 and second beamforming transmission 1026 may overlap in time and frequency. In an implementation, AP 1002 may transmit a trigger frame 1022 to trigger first beamforming transmission 1024 and second beamforming transmission 1026. Trigger frame 1022 may be a MAP trigger frame. APs 1002 and 1004 may begin first beamforming transmission 1024 and second beamforming transmission 1026 a short interframe space (SIFS) after transmission of trigger frame 1022 by AP 1002.

In an implementation, AP 1002 may compute a first set of beamforming weights for first beamforming transmission 1024 based on the estimate of the downlink channel from AP 1002 to STA 1006 and/or on the estimate of the downlink channel from AP 1002 to STA 1008. Similarly, AP 1004 may compute a second set of beamforming weights for second beamforming transmission 1026 based on the estimate of the downlink channel from AP 1004 to STA 1006 and/or on the estimate of the downlink channel from AP 1004 to STA 1008. In one approach, the first set of beamforming weights may be configured such that first beamforming transmission 1024 comprise a first beam carrying a first data stream in the direction of STA 1006 and a null beam in the direction of STA 1008. Hence, beamforming transmission 1024 does not affect the capability of STA 1008 to receive a frame from another STA (e.g., AP 1004). Similarly, the second set of beamforming weights may be configured such that second beamforming transmission 1026 comprise a second beam carrying a second data stream in the direction of STA 1008 and a null beam in the direction of STA 1006. Hence, beamforming transmission 1026 does not affect the capability of STA 1006 to receive a frame from another STA (e.g., AP 1002).

However, in practice, beamforming weight calculation is a vendor-specific implementation. Different vendors/implementers may use different beamforming weight calculation algorithms, resulting in a sub-optimal nulling performance. For example, referring to FIG. 10, APs 1002 and 1004 may be devices produced by different vendors/implementers and may thus use different beamforming weight calculation algorithms to generate the first set of beamforming weights and the second set of beamforming weights respectively. First beamforming transmission 1024 may thus comprise a non-null beam in the direction of STA 1008 and may interfere with the reception of STA 1008 of the second data stream carried in second beamforming transmission 1026. Similarly, second beamforming transmission 1026 may comprise a non-null beam in the direction of STA 1006 and may interfere with the reception of STA 1006 of the first data stream carried in first beamforming transmission 1024.

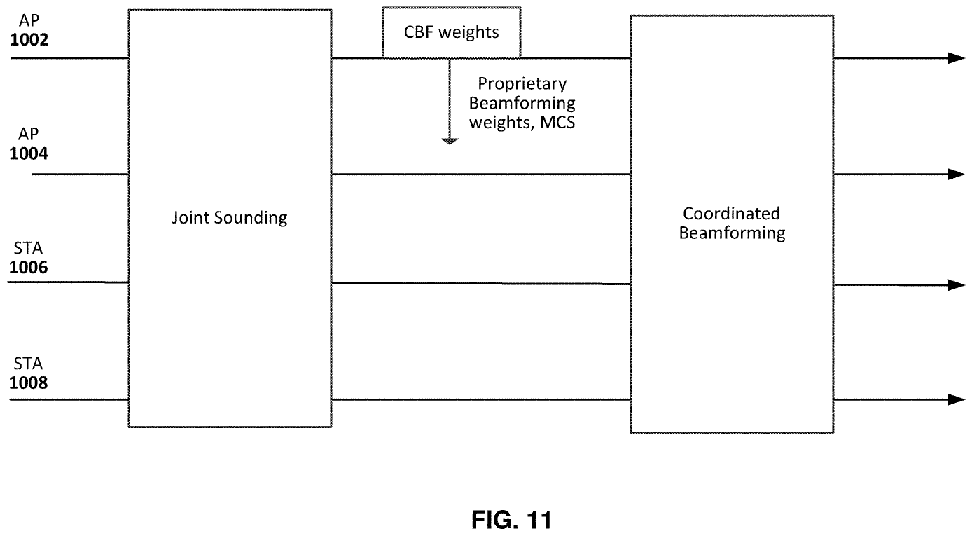

One solution to this problem, as illustrated in FIG. 11, may include AP 1002 transmitting to AP 1004 a set of beamforming weights, and optionally an indication of an MCS, for use in the coordinated beamforming transmission. The set of beamforming weights may be determined by AP 1002, for AP 1004, using the same beamforming calculation algorithm used by AP 1002 to determine its own set of beamforming weights. However, this solution would incur significant overhead particularly as the number of streams increases.

Embodiments of the present disclosure, as further described above, address the above-described problem of existing coordinated beamforming procedures. In an aspect, a first AP receives from a second AP a frame indicating a beamforming transmission by the first AP and the second AP and an acceptable receive interference level (ARIL), at a first STA associated with the second AP, of a PPDU transmitted, by the first AP to a second STA associated with the first AP, for the beamforming transmission. The first AP transmits to the second STA and for the beamforming transmission the PPDU beamformed based on the ARIL. In an embodiment, the first AP determines, based on the ARIL, a set of beamforming weights for the beamforming transmission. The first AP transmits the PPDU beamformed based on the set of beamforming weights. In an embodiment, the set of beamforming weights are determined such that an interference level at the first STA due to the first PPDU is lower than the ARIL. Nulling performance of the beamforming transmission is hence improved.

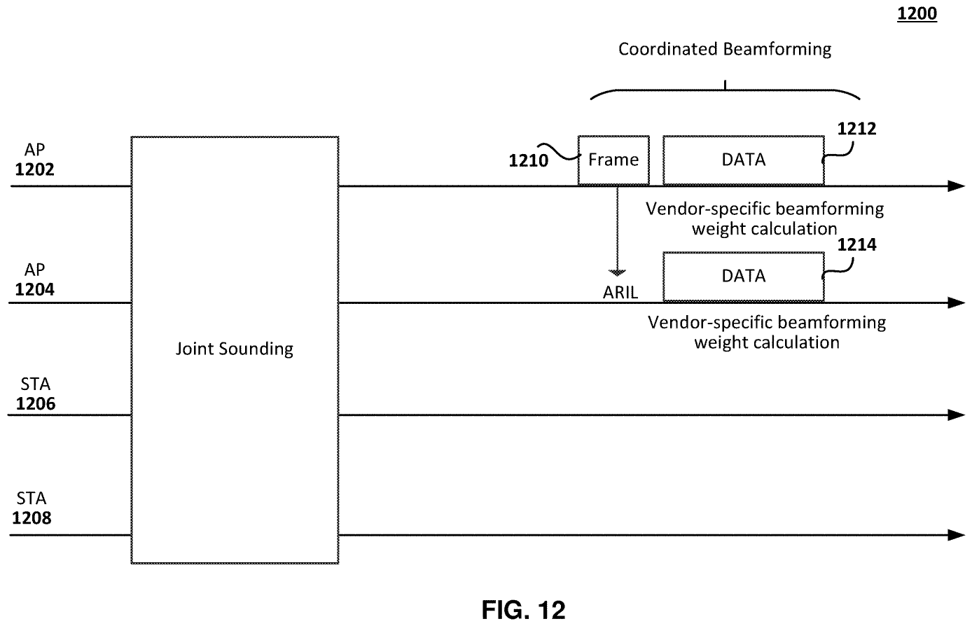

FIG. 12 illustrates an example 1200 of a coordinated beamforming procedure according to an embodiment. As shown in FIG. 12, example 1200 includes APs 1202 and 1204 and STAs 1206 and 1208. STAs 1206 and 1208 may be associated with APs 1202 and 1204 respectively. APs 1202 and 1204 may form a coordinated AP set. In example 1200, it is assumed that AP 1202 is a master AP of the coordinated AP set and that AP 1204 is a slave AP of the coordinated AP set.

In an embodiment, the coordinated beamforming procedure may include a sounding phase/procedure, which APs 1202 and 1204 may use to acquire channel state information from STAs 1206 and 1208 respectively. The sounding phase/procedure may be similar to the sounding procedure described above with reference to FIG. 10. At the end of the sounding phase/procedure, APs 1002 and 1004 receive respective BFR frames from STAs 1206 and 1208, respectively. The BFR frame, transmitted by STA 1206 to AP 1202, may include an estimate of the downlink channel from AP 1202 to STA 1206 and an estimate of the downlink channel from AP 1204 to STA 1206. The BFR frame, transmitted by STA 1208 to AP 1204, may include an estimate of the downlink channel from AP 1204 to STA 1208 and an estimate of the downlink channel from AP 1202 to STA 1208. In an implementation, APs 1202 and 1204 may exchange the downlink channel estimates received respectively from STAs 1206 and 1208. As such, AP 1202 may obtain from AP 1204 the estimate of the downlink channel from AP 1202 to STA 1208, and AP 1204 may obtain from AP 1202 the estimate of the downlink channel from AP 1204 to STA 1206. In an implementation, the exchange of the downlink channel estimates may include AP 1202 transmitting a trigger frame to AP 1204 soliciting the sending, by AP 1204 to AP 1202, of the downlink channel estimates received from STA 1208. AP 1202 may include the downlink channel estimates received from STA 1206 in the trigger frame or in a separate frame transmitted to AP 1204. In another implementation, the exchange of the downlink channel estimates may be performed via a backhaul link.

In an embodiment, after the sounding phase/procedure, AP 1202 may transmit a frame 1210 to AP 1204. Frame 1210 may indicate a beamforming transmission by AP 1202 and AP 1204. The beamforming transmission may be a coordinated beamforming transmission. For example, frame 1210 may indicate a start time of the beamforming transmission and/or an end time of the beamforming transmission. In an example, the start time of the beamforming transmission may be a SIFS after an end of frame 1210.

Frame 1210 may further indicate a first acceptable receive interference level (ARIL) at STA 1206 of (or due to) a first PPDU 1214 to be transmitted, by AP 1204 to STA 1208, for/during the beamforming transmission. In an implementation, the first ARIL is determined by AP 1202 based on a beamforming report element from STA 1208. AP 1202 may obtain the beamforming report element from AP 1204 to which STA 1208 transmits the beamforming report element. In an example, the beamforming report element may include an estimate of the downlink channel from AP 1204 to STA 1208. In another embodiment, the beamforming report element may, additionally or alternatively, include an estimate of the downlink channel from AP 1202 to STA 1208. In an implementation, the first ARIL may be determined by AP 1202 based on one or more of an estimate of the downlink channel from AP 1204 to STA 1208 and an estimate of the downlink channel from AP 1202 to STA 1208. In an embodiment, frame 1210 may further comprise an indication of an MCS for use by AP 1204 for the beamforming transmission. In an implementation, the indication of the MCS for use by AP 1204 may comprise an indication of an interference level at STA 1208. In an implementation, the interference level at STA 1208 may comprise an estimated interference level at STA 1208 due to PPDU 1212 that is transmitted by AP 1202. AP 1204 may use an estimate of the downlink channel from AP 1204 to STA 1208 to determine a maximum (highest order) MCS that may be decoded successfully by STA 1208 given the indicated estimated interference level at STA 1208.

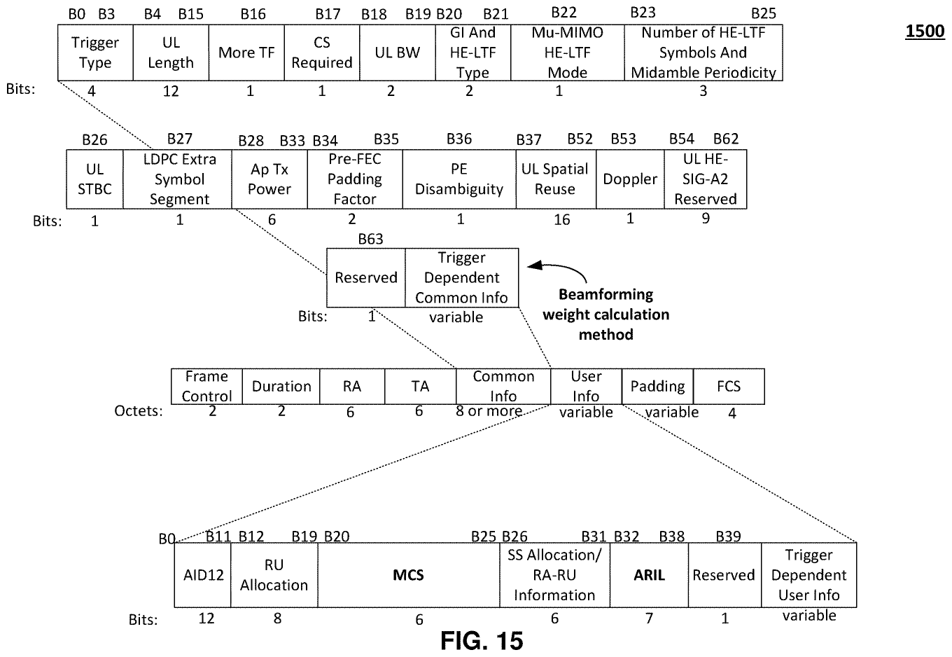

In an implementation, frame 1210 may be a trigger frame. The trigger frame may have a format as illustrated by example trigger frame 1500 shown in FIG. 15. Example trigger frame 1500 may be a multi-AP trigger frame as indicated by a trigger type field. In an implementation, the trigger frame comprises a user info field, associated with AP 1204, that indicates the first ARIL and/or an MCS for use by AP 1204. The user info field associated with AP 1204 may include an identifier of AP 1204. In an implementation, the first ARIL may be indicated in bits B32 to B38 of the user info field as shown in FIG. 15. In an implementation, the MCS may be indicated in bits B20 to B25 of the user info field as shown in FIG. 15. In another implementation, the estimated interference level at STA 1208 may be indicated in the user info field in bits B20 to B25 as an alternative to the MCS. In an implementation, the trigger frame may comprise a common info field that indicates the beamforming transmission.

In an embodiment, using the obtained downlink channel estimates, APs 1202 and 1204 may compute respectively first and second sets of beamforming weights for the beamforming transmission. In an implementation, APs 1202 and 1204 may each further determine a respective MCS for the beamforming transmission. As shown in FIG. 12, APs 1202 and 1204 may use proprietary or vendor-specific algorithms for determining the respective first and second sets of beamforming weights for the beamforming transmission. That is, APs 1202 and 1204 may determine the first and second sets of beamforming weights independently.

In an embodiment, AP 1204 may use the first ARIL indicated in frame 1210 in determining the second set of beamforming weights for the beamforming transmission. In an implementation, AP 1204 uses the first ARIL to determine the second set of beamforming weights such that it results in an interference level, at STA 1206 due to first PPDU 1214, that is lower than the first ARIL. This ensures that the nulling performance of the beamforming transmission meets a minimum acceptable performance. In another embodiment, after determining the second set of beamforming weights, AP 1204 may reduce a transmit power, based on the first ARIL, to transmit first PPDU 1214.

Subsequently, as shown in FIG. 12, APs 1202 and 1204 may perform the beamforming transmission comprising transmission by AP 1202 of a PPDU 1212 to STA 1206 and transmission by AP 1204 of PPDU 1214 to STA 1208. As mentioned above, PPDUs 1212 and 1214 may be beamformed based on the first and second sets of beamforming weights determined by APs 1202 and 1204 respectively. Further, PPDU 1214 may be beamformed based on the first ARIL indicated in frame 1210 as described above.

In an implementation, frame 1210 may be a trigger frame that triggers the beamforming transmission by APs 1202 and 1204. APs 1202 and 1204 may begin transmission of PPDUs 1212 and 1214 a SIFS after an end of frame 1210.

In one approach, the first set of beamforming weights may be configured such that PPDU 1212 comprises a first beam carrying a first data stream in the direction of STA 1206 and a null beam in the direction of STA 1208. Hence, PPDU 1212 does not affect the capability of STA 1208 to receive PPDU 1214 from AP 1204. Similarly, the second set of beamforming weights may be configured such that PPDU 1214 comprises a second beam carrying a second data stream in the direction of STA 1208 and a null beam in the direction of STA 1206. More specifically, the interference level due to PPDU 1214 at STA 1206 is lower than the first ARIL indicated in frame 1210. Hence, PPDU 1214 does not affect the capability of STA 1206 to receive PPDU 1212 from AP 1202.

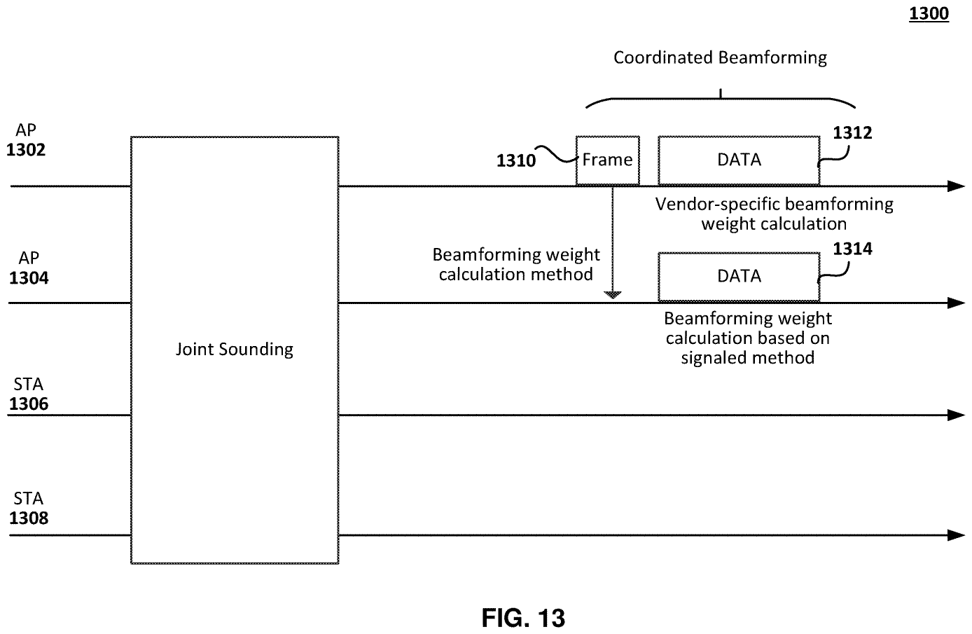

FIG. 13 illustrates an example 1300 of another coordinated beamforming procedure according to an embodiment. As shown in FIG. 13, example 1300 includes APs 1302 and 1304 and STAs 1306 and 1308. STAs 1306 and 1308 may be associated with APs 1302 and 1304 respectively. APs 1302 and 1304 may form a coordinated AP set. In example 1300, it is assumed that AP 1302 is a master AP of the coordinated AP set and that AP 1304 is a slave AP of the coordinated AP set.

In an embodiment, the coordinated beamforming procedure may include a sounding phase/procedure, which APs 1302 and 1304 may use to acquire channel state information from STAs 1306 and 1308 respectively. The sounding phase/procedure may be similar to the sounding procedure described above with reference to FIG. 10. At the end of the sounding phase/procedure, APs 1002 and 1004 receive respective BFR frames from STAs 1306 and 1308, respectively. The BFR frame, transmitted by STA 1306 to AP 1302, may include an estimate of the downlink channel from AP 1302 to STA 1306 and an estimate of the downlink channel from AP 1304 to STA 1306. The BFR frame, transmitted by STA 1308 to AP 1304, may include an estimate of the downlink channel from AP 1304 to STA 1308 and an estimate of the downlink channel from AP 1302 to STA 1308. In an implementation, APs 1302 and 1304 may exchange the downlink channel estimates received respectively from STAs 1306 and 1308. As such, AP 1302 may obtain from AP 1304 the estimate of the downlink channel from AP 1302 to STA 1308, and AP 1304 may obtain from AP 1302 the estimate of the downlink channel from AP 1304 to STA 1306. In an implementation, the exchange of the downlink channel estimates may include AP 1302 transmitting a trigger frame to AP 1304 soliciting the sending, by AP 1304 to AP 1302, of the downlink channel estimates received from STA 1308. AP 1302 may include the downlink channel estimates received from STA 1306 in the trigger frame or in a separate frame transmitted to AP 1304. In another implementation, the exchange of the downlink channel estimates may be performed via a backhaul link.

In an embodiment, after the sounding phase/procedure, AP 1302 may transmit a frame 1310 to AP 1304. Frame 1310 may indicate a beamforming transmission by AP 1302 and AP 1304. The beamforming transmission may be a coordinated beamforming transmission. For example, frame 1310 may indicate a start time of the beamforming transmission and/or an end time of the beamforming transmission. In an example, the start time of the beamforming transmission may be a SIFS after an end of frame 1310.

In an embodiment, rather than explicitly indicate the first ARIL as in the embodiment of FIG. 12, frame 1310 may indicate a method for determining a set of beamforming weights for PPDU 1314. The method for determining the set of beamforming weights for PPDU 1314 may be configured, when used by AP 1304 to transmit PPDU 1314, to result in an interference level due to PPDU 1314 at STA 1306 that is equal or lower than the first ARIL. In an implementation, the method for determining the set of beamforming weights for PPDU 1314 may be based on linear minimum mean square error (MMSE) beamforming. In another implementation, the method for determining the set of beamforming weights for PPDU 1314 may be based on zero forcing beamforming.

In an embodiment, frame 1310 may further comprise an indication of an MCS for use by AP 1304 for the beamforming transmission. In an implementation, the indicated MCS may also be for use by AP 1302 for the beamforming transmission. In an implementation, the indication of the MCS in frame 1310 may comprise an indication of an interference level at STA 1308. In an implementation, the interference level at STA 1308 may comprise an estimated interference level at STA 1308 due to PPDU 1312 that is transmitted by AP 1302. AP 1304 may use an estimate of the downlink channel from AP 1304 to STA 1308 to determine a maximum MCS (highest order) that may be decoded successfully by STA 1308 given the indicated estimated interference level at STA 1308.

In an implementation, frame 1310 may be a trigger frame. The trigger frame may have a format as illustrated by example trigger frame 1500 shown in FIG. 15. Example trigger frame 1500 may be a multi-AP trigger frame as indicated by a trigger type field. In an implementation, the trigger frame comprises a user info field, associated with AP 1304. In an implementation, the MCS may be indicated in bits B20 to B25 of the user info field as shown in FIG. 15. In another implementation, the estimated interference level at STA 1308 may be indicated in the user info field in bits B20 to B25 as an alternative to the MCS. The user info field associated with AP 1304 may include an identifier of AP 1304. In an implementation, the trigger frame may comprise a common info field that indicates the beamforming transmission. In an implementation, the common info field may also include the method for determining the beamforming weights for PPDU 1314. For example, the method may be indicated in a trigger dependent common info field of the common info field.

In an embodiment, using the obtained downlink channel estimates, APs 1302 and 1304 may compute respectively first and second sets of beamforming weights for the beamforming transmission. In an implementation, APs 1302 and 1304 may each further determine a respective MCS for the beamforming transmission. In an embodiment, as shown in FIG. 13, AP 1302 may use a proprietary or vendor-specific algorithm for determining the first set of beamforming weights for the beamforming transmission. In contrast, AP 1304 may use the beamforming weight calculation method indicated in frame 1310 to determine the second set of beamforming weights for the beamforming transmission. The beamforming weight calculation method indicated in frame 1310 may be the same method used by AP 1302.

Subsequently, as shown in FIG. 13, APs 1302 and 1304 may perform the beamforming transmission comprising transmission by AP 1302 of a PPDU 1312 to STA 1306 and transmission by AP 1304 of PPDU 1314 to STA 1308. As mentioned above, PPDUs 1312 and 1314 may be beamformed based on the first and second sets of beamforming weights determined by APs 1302 and 1304 respectively.

In an implementation, frame 1310 may be a trigger frame that triggers the beamforming transmission by APs 1302 and 1304. APs 1302 and 1304 may begin transmission of PPDUs 1312 and 1314 a SIFS after an end of frame 1310.

In one approach, the first set of beamforming weights may be configured such that PPDU 1312 comprise a first beam carrying a first data stream in the direction of STA 1306 and a null beam in the direction of STA 1308. Hence, PPDU 1312 does not affect the capability of STA 1308 to receive PPDU 1314 from AP 1304. Similarly, the second set of beamforming weights may be configured such that PPDU 1314 comprise a second beam carrying a second data stream in the direction of STA 1308 and a null beam in the direction of STA 1306. Hence, PPDU 1314 does not affect the capability of STA 1306 to receive PPDU 1312 from AP 1302.

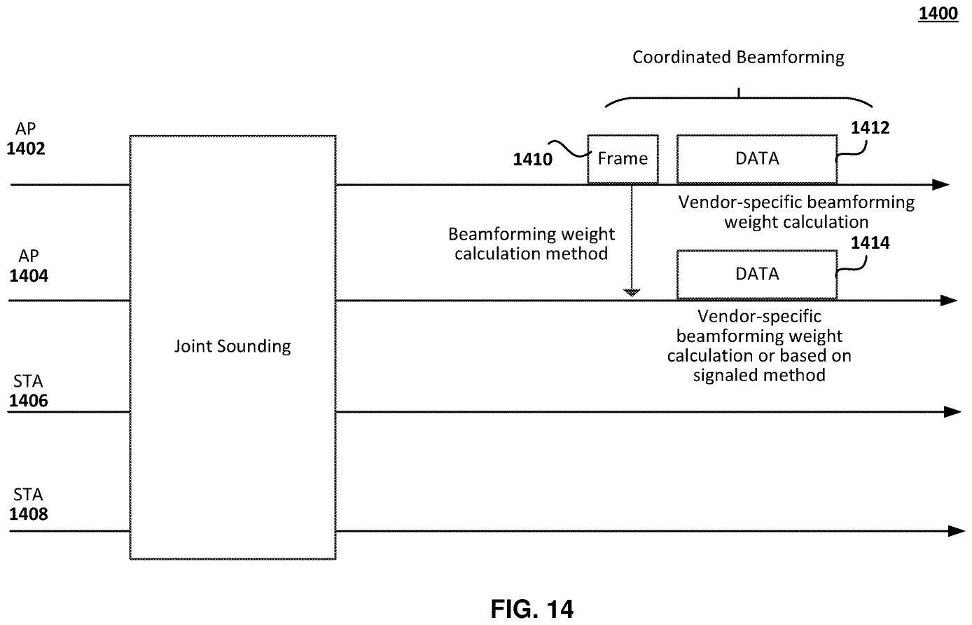

FIG. 14 illustrates an example 1400 of another coordinated beamforming procedure according to an embodiment. As shown in FIG. 14, example 1400 includes APs 1402 and 1404 and STAs 1406 and 1408. STAs 1406 and 1408 may be associated with APs 1402 and 1404 respectively. APs 1402 and 1404 may form a coordinated AP set. In example 1400, it is assumed that AP 1402 is a master AP of the coordinated AP set and that AP 1404 is a slave AP of the coordinated AP set.

In an embodiment, the coordinated beamforming procedure may include a sounding phase/procedure, which APs 1402 and 1404 may use to acquire channel state information from STAs 1406 and 1408 respectively. The sounding phase/procedure may be similar to the sounding procedure described above with reference to FIG. 10. At the end of the sounding phase/procedure, APs 1002 and 1004 receive respective BFR frames from STAs 1406 and 1408, respectively. The BFR frame, transmitted by STA 1406 to AP 1402, may include an estimate of the downlink channel from AP 1402 to STA 1406 and an estimate of the downlink channel from AP 1404 to STA 1406. The BFR frame, transmitted by STA 1408 to AP 1404, may include an estimate of the downlink channel from AP 1404 to STA 1408 and an estimate of the downlink channel from AP 1402 to STA 1408. In an implementation, APs 1402 and 1404 may exchange the downlink channel estimates received respectively from STAs 1406 and 1408. As such, AP 1402 may obtain from AP 1404 the estimate of the downlink channel from AP 1402 to STA 1408, and AP 1404 may obtain from AP 1402 the estimate of the downlink channel from AP 1404 to STA 1406. In an implementation, the exchange of the downlink channel estimates may include AP 1402 transmitting a trigger frame to AP 1404 soliciting the sending, by AP 1404 to AP 1402, of the downlink channel estimates received from STA 1408. AP 1402 may include the downlink channel estimates received from STA 1406 in the trigger frame or in a separate frame transmitted to AP 1404. In another implementation, the exchange of the downlink channel estimates may be performed via a backhaul link.

In an embodiment, after the sounding phase/procedure, AP 1402 may transmit a frame 1410 to AP 1404. Frame 1410 may indicate a beamforming transmission by AP 1402 and AP 1404. The beamforming transmission may be a coordinated beamforming transmission. For example, frame 1410 may indicate a start time of the beamforming transmission and/or an end time of the beamforming transmission. In an example, the start time of the beamforming transmission may be a SIFS after an end of frame 1410.

Frame 1410 may further indicate a method for determining a set of beamforming weights for a PPDU to be transmitted by AP 1404 for/during the beamforming transmission. In an implementation, the method for determining the set of beamforming weights may be based on linear MMSE beamforming. In another implementation, the method for determining the set of beamforming weights may be based on zero forcing beamforming.

In an embodiment, frame 1410 may further comprise an indication of an MCS for use by AP 1404 for the beamforming transmission. In an implementation, the indication of the MCS in frame 1410 may comprise an indication of a first ARIL at STA 1408. In an implementation, the first ARIL may comprise an interference level at STA 1408 due to PPDU 1412 that is transmitted by AP 1402. AP 1404 may use an estimate of the downlink channel from AP 1404 to STA 1408 to determine a maximum (highest order) MCS that may be decoded successfully by STA 1408 given the indicated first ARIL.

In an implementation, frame 1410 may be a trigger frame. The trigger frame may have a format as illustrated by example trigger frame 1500 shown in FIG. 15. Example trigger frame 1500 may be a multi-AP trigger frame as indicated by a trigger type field. In an implementation, the trigger frame comprises a user info field, associated with AP 1404, that indicates the method for determining the beamforming weights for the PPDU to be transmitted by AP 1404 and/or the MCS for use by AP 1404. In an implementation, the MCS may be indicated in bits B20 to B25 of the user info field as shown in FIG. 15. In another implementation, the first ARIL may be indicated in the user info field in bits B20 to B25 as an alternative to the MCS. The user info field associated with AP 1404 may include an identifier of AP 1404. In another implementation, the trigger frame may comprise a common info field that includes the method for determining the beamforming weights for the PPDU to be transmitted by AP 1404. For example, the method may be indicated in a trigger dependent common info field of the common info field. In an implementation, the common info field indicates the beamforming transmission.

In an embodiment, using the obtained downlink channel estimates, APs 1402 and 1404 may compute respectively first and second sets of beamforming weights for the beamforming transmission. In an implementation, APs 1402 and 1404 may each further determine a respective MCS for the beamforming transmission. In an embodiment, as shown in FIG. 14, AP 1402 may use a proprietary or vendor-specific algorithm for determining the first set of beamforming weights for the beamforming transmission. In an embodiment, AP 1404 may use the beamforming weight calculation method indicated in frame 1410 to compute an ARIL at STA 1406 for the PPDU to be transmitted by AP 1404. In an example, a beamforming weight matrix determined using the beamforming weight calculation method may be expressed as W for a subcarrier j of the PPDU. Correspondingly, a downlink channel matrix from AP 1404 to STA 1406 may be expressed as H. In an implementation, H may be obtained by AP 1404 using the joint sounding procedure detailed in reference to example 1000 described above. AP 1404 may then compute the ARIL as |W^{H}y−x|\hat{ }2, where y is the estimated received signal for the subcarrier j and x is a transmit symbol. In an example, the estimated received signal y for the subcarrier j, given an estimated noise level n and the transmit symbol x, may be expressed as y=Hx+n. After computing the ARIL, AP 1404 may use a proprietary or vendor-specific algorithm for determining the second set of beamforming weights for the beamforming transmission on condition that a resulting ARIL using the determined second set of beamforming weights is lower than or equal to the computed ARIL. Otherwise, if the resulting ARIL using the determined second set of beamforming weights is higher than the computed ARIL, AP 1404 may use the beamforming weight calculation method indicated in frame 1410 to determine the second set of beamforming weights for the beamforming transmission.

Subsequently, as shown in FIG. 14, APs 1402 and 1404 may perform the beamforming transmission comprising transmission by AP 1402 of a PPDU 1412 to STA 1406 and transmission by AP 1404 of a PPDU 1414 to STA 1408. As mentioned above, PPDUs 1412 and 1414 may be beamformed based on the first and second sets of beamforming weights determined by APs 1402 and 1404 respectively.

In an implementation, frame 1410 may be a trigger frame that triggers the beamforming transmission by APs 1402 and 1404. APs 1402 and 1404 may begin transmission of PPDUs 1412 and 1414 a SIFS after an end of frame 1410.

In one approach, the first set of beamforming weights may be configured such that PPDU 1412 comprise a first beam carrying a first data stream in the direction of STA 1406 and a null beam in the direction of STA 1408. Hence, PPDU 1412 does not affect the capability of STA 1408 to receive PPDU 1414 from AP 1404. Similarly, the second set of beamforming weights may be configured such that PPDU 1414 comprise a second beam carrying a second data stream in the direction of STA 1408 and a null beam in the direction of STA 1406. More specifically, the interference level due to PPDU 1414 at STA 1406 is lower than the first ARIL indicated in frame 1410. Hence, PPDU 1414 does not affect the capability of STA 1406 to receive PPDU 1412 from AP 1402.

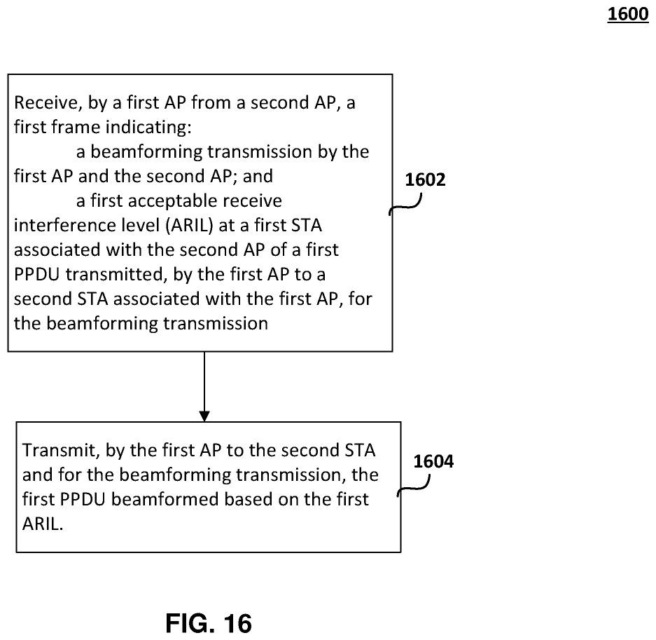

FIG. 16 illustrates an example process 1600 according to an embodiment. Example process 1600 is provided for the purpose of illustration only and is not limiting of embodiments. Example process 1600 may be performed by a first AP, such as AP 1204, 1304, or 1404, for example. As shown in FIG. 16, process 1600 may include steps 1602 and 1604.

Step 1602 includes receiving, by the first AP from a second AP, a first frame indicating: a beamforming transmission by the first AP and the second AP; and a first ARIL at a first STA associated with the second AP of a first PPDU transmitted, by the first AP to a second STA associated with the first AP, for the beamforming transmission. In an embodiment, the first AP and the second AP are members of a coordinated AP set. In an embodiment, the first AP may be a slave AP and the second AP may be a master AP of the coordinated AP set. In an embodiment, the beamforming transmission comprises a coordinated beamforming transmission.

Step 1604 includes transmitting, by the first AP to the second STA and for the beamforming transmission, the first PPDU beamformed based on the first ARIL.

In an embodiment, process 1600 may further comprise determining a first set of beamforming weights such that an interference level at the first STA due to the first PPDU is lower than the first ARIL. In an embodiment, transmitting the first PPDU in step 1604 may further comprise transmitting the first PPDU using the first set of beamforming weights.

In another embodiment, the first frame indicates a method for determining a set of beamforming weights for the first PPDU. In an embodiment, transmitting the first PPDU in step 1604 may further comprise transmitting the first PPDU using the set of beamforming weights determined using the indicated method. In an embodiment, the method for determining the set of beamforming weights for the first PPDU may be based on linear minimum mean square error (MMSE) beamforming or on zero forcing beamforming.

In another embodiment, rather than explicitly indicating the first ARIL in the first frame, the first frame indicates a method for determining a set of beamforming weights for the first PPDU. Process 1600 may further comprise determining, by the first AP, an interference level using the method for determining the set of beamforming weights for the first PPDU. In an embodiment, the determined interference level corresponds to the first ARIL.

In an embodiment, the first frame comprises a trigger frame. In an embodiment, the trigger frame comprises a user info field associated with the first AP, and the user info field indicates the first ARIL. In an embodiment, the trigger frame comprises a common info field, and the common info field indicates the beamforming transmission.

In an embodiment, transmitting the first PPDU in step 1604 comprises transmitting a first beam carrying a second frame in the direction of the second STA and a null beam in the direction of the first STA.

In an embodiment, process 1600 may further comprise receiving, by the first AP from the second AP, a third frame triggering the first AP to perform a sounding procedure. In an embodiment, the sounding procedure comprises transmitting, by the first AP, a null data packet (NDP); and receiving, by the first AP from the second STA, a third frame comprising a beamforming report element associated with a channel between the first AP and the second STA. In an embodiment, the first ARIL is based on the beamforming report element.

In an embodiment, process 1600 may further comprise reducing a transmit power for transmitting the first PPDU based on the first ARIL.

In an embodiment, the first frame further comprises an indication of an MCS. Process 1600 may further comprise transmitting the first PPDU using the MCS. In an embodiment, the indication of the MCS comprises an indication of an interference level at the second STA. In an implementation, the interference level at the second STA may comprise an estimated interference level at the second STA due to a second PPDU transmitted by the second AP. The first AP may use an estimate of the downlink channel from first AP to the second STA to determine the MCS for use by the first AP for the beamforming transmission based on the estimated interference level at the second STA.

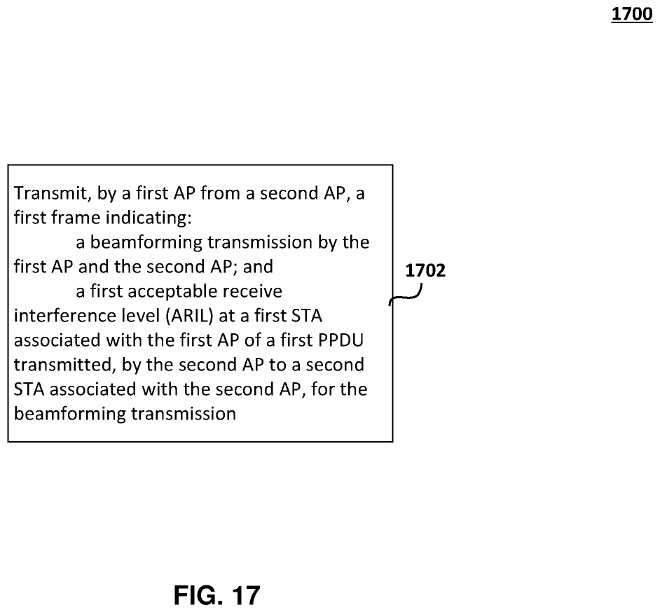

FIG. 17 illustrates another example process 1700 according to an embodiment. Example process 1700 is provided for the purpose of illustration only and is not limiting of embodiments. Example process 1700 may be performed by a first AP, such as AP 1202, 1302, or 1402, for example.

As shown in FIG. 17, process 1700 includes step 1702, which includes transmitting, by the first AP to a second AP, a first frame indicating: a beamforming transmission by the first AP and the second AP; and a first ARIL at a first STA associated with the first AP of a first PPDU transmitted by the second AP to a second STA associated with the second AP for the beamforming transmission. In an embodiment, the first AP and the second AP are members of a coordinated AP set. In an embodiment, the first AP may be a master AP and the second AP may be a slave AP of the coordinated AP set. In an embodiment, the beamforming transmission comprises a coordinated beamforming transmission.

In another embodiment, the first frame indicates a method for determining a set of beamforming weights for the first PPDU. In an embodiment, the method for determining the set of beamforming weights for the first PPDU may be based on linear minimum mean square error (MMSE) beamforming or on zero forcing beamforming.

In another embodiment, rather than explicitly indicating the first ARIL in the first frame, the first frame indicates a method for determining a set of beamforming weights for the first PPDU. An interference level of the first PPDU, determined using the set of beamforming weights for the first PPDU, corresponds to the first ARIL.

In an embodiment, the first frame comprises a trigger frame. In an embodiment, the trigger frame comprises a user info field associated with the second AP, and the user info field indicates the first ARIL. In an embodiment, the trigger frame comprises a common info field, and the common info field indicates the beamforming transmission.

In an embodiment, process 1700 may further comprise transmitting, by the first AP, a second PPDU comprising a first beam carrying a second frame in the direction of the first STA and a null beam in the direction of the second STA.

In an embodiment, process 1700 may further comprise transmitting, by the first AP to the second AP, a third frame triggering the second AP to perform a sounding procedure. In an embodiment, the sounding procedure comprises transmitting, by the first AP, a null data packet (NDP); and receiving, by the first AP from the first STA, a third frame comprising a beamforming report element associated with a channel between the second AP and the first STA. In an embodiment, the first ARIL is based on the beamforming report element.

In an embodiment, the first frame further comprises an indication of an MCS, and the first PPDU is transmitted using the MCS. In an embodiment, the indication of the MCS comprises an indication of an interference level at the second STA. In an implementation, the interference level at the second STA may comprise an estimated interference level at the second STA due to a second PPDU transmitted by the first AP. The second AP may use an estimate of the downlink channel from second AP to the second STA to determine the MCS for use by the second AP for the beamforming transmission based on the estimated interference level at the second STA.

1. A method comprising:
receiving, by a first access point (AP) from a second AP and during a coordinated beamforming sounding sequence initiated by the second AP, a null data physical layer protocol data unit (NDP) announcement soliciting a sounding NDP from the first AP;
transmitting, by the first AP and based on the sounding NDP announcement, the sounding NDP;
receiving, by the first AP from the second AP and after the coordinated beamforming sounding sequence, a trigger frame indicating:
a coordinated beamforming transmission by the first AP and the second AP;
the first AP; and
a first modulation and coding scheme (MCS), for transmission of a first data physical layer protocol data unit (PPDU) by the first AP to a first station (STA) associated with the first AP, for the coordinated beamforming transmission; and
transmitting, by the first AP to the first STA and for the coordinated beamforming transmission, the first data PPDU using the first MCS.

2. The method of claim 1, wherein the trigger frame comprises a common info field indicating the coordinated beamforming transmission.

3. The method of claim 2, wherein the trigger frame comprises a plurality of user info fields indicating the first AP, the second AP, and the first MCS.

4. The method of claim 3, wherein based on receiving the trigger frame, the first AP transmits the first data PPDU to the first STA a short interframe space (SIFS) after an end of a third PPDU carrying the trigger frame.

5. The method of claim 4, wherein the first AP transmits to the first STA the first data PPDU simultaneously with the second AP transmitting a second data PPDU to a second STA associated with the second AP.

6. The method of claim 5, further comprising: receiving, by the first AP from the first STA, an acknowledgment frame in response to the first data PPDU.

7. The method of claim 6, wherein the trigger frame comprises a coordinated beamforming trigger frame.

8. A first access point (AP) comprising:
one or more processors; and
memory storing instructions that, when executed by the one or more processors, cause the first AP to:
receive, by the first AP from a second AP and during a coordinated beamforming sounding sequence initiated by the second AP, a null data physical layer protocol data unit (NDP) announcement soliciting a sounding NDP from the first AP;
transmit, by the first AP and based on the sounding NDP announcement, the sounding NDP;
receive, by the first AP from the second AP and after the coordinated beamforming sounding sequence, a trigger frame indicating:
a coordinated beamforming transmission by the first AP and the second AP;
the first AP; and
a first modulation and coding scheme (MCS), for transmission of a first data physical layer protocol data unit (PPDU) by the first AP to a first station (STA) associated with the first AP, for the coordinated beamforming transmission; and
transmit, by the first AP to the first STA and for the coordinated beamforming transmission, the first data PPDU using the first MCS.

9. The first AP of claim 8, wherein the trigger frame comprises a common info field indicating the coordinated beamforming transmission.

10. The first AP of claim 9, wherein the trigger frame comprises a plurality of user info fields indicating the first AP, the second AP, and the first MCS.

11. The first AP of claim 10, wherein based on receiving the trigger frame, the first AP transmits the first data PPDU to the first STA a short interframe space (SIFS) after an end of a third PPDU carrying the trigger frame.

12. The first AP of claim 11, wherein the first AP transmits to the first STA the first data PPDU simultaneously with the second AP transmitting a second data PPDU to a second STA associated with the second AP.

13. The first AP of claim 12, wherein the memory stores instructions that, when executed by the one or more processors, cause the first AP to: receive, by the first AP from the first STA, an acknowledgment frame in response to the first data PPDU.

14. The first AP of claim 13, wherein the trigger frame comprises a coordinated beamforming trigger frame.

15. A non-transitory computer-readable medium comprising instructions that, when executed by one or more processors of a first access point (AP), cause the first AP to:
receive, by the first AP from a second AP and during a coordinated beamforming sounding sequence initiated by the second AP, a null data physical layer protocol data unit (NDP) announcement soliciting a sounding NDP from the first AP;
transmit, by the first AP and based on the sounding NDP announcement, the sounding NDP;
receive, by the first AP from the second AP and after the coordinated beamforming sounding sequence, a trigger frame indicating:
a coordinated beamforming transmission by the first AP and the second AP;
the first AP; and
a first modulation and coding scheme (MCS), for transmission of a first data physical layer protocol data unit (PPDU) by the first AP to a first station (STA) associated with the first AP, for the coordinated beamforming transmission; and
transmit, by the first AP to the first STA and for the coordinated beamforming transmission, the first data PPDU using the first MCS.

16. The non-transitory computer-readable medium of claim 15, wherein the trigger frame comprises a common info field indicating the coordinated beamforming transmission.

17. The non-transitory computer-readable medium of claim 16, wherein the trigger frame comprises a plurality of user info fields indicating the first AP, the second AP, and the first MCS.

18. The non-transitory computer-readable medium of claim 17, wherein based on receiving the trigger frame, the first AP transmits the first data PPDU to the first STA a short interframe space (SIFS) after an end of a third PPDU carrying the trigger frame.

19. The non-transitory computer-readable medium of claim 18, wherein the first AP transmits to the first STA the first data PPDU simultaneously with the second AP transmitting a second data PPDU to a second STA associated with the second AP.

20. The non-transitory computer-readable medium of claim 19, wherein the instructions, when executed by the one or more processors of the first AP, cause the first AP to: receive, by the first AP from the first STA, an acknowledgment frame in response to the first data PPDU.
